(19) United States
(12) Patent Application Publication
(10) Pub. No.: US 2014/0161932 A1
(43) Pub. Date: Jun. 12, 2014

(54) PRODUCTION METHOD OF WHITE CHEESE IN BRINE USING STACKABLE TRAYS AND PALLET TANKS OR ONLY PALLET TANKS

(71) Applicant: Christos Kogioumtzis, Sindos (GR)

(72) Inventor: Christos Kogioumtzis, Sindos (GR)

(21) Appl. No.: 14/236,207

(22) PCT Filed: Jul. 27, 2012
(86) PCT No.: PCT/GR2012/000035

§ 371 Date: Jan. 30, 2014

(30) Foreign Application Priority Data
Aug. 1, 2011 (GR) 20110100454

(51) Int. Cl. A23C 19/14

(52) U.S. Cl. CPC A23C 19/14
USPC 426/36; 99/452

(57) ABSTRACT

Production procedure of white cheese in brine, using stackable trays and pallet tanks, or only pallet tanks, consisted of a tray for dry salting (1) with suitable depth, tight on three sides and reinforced at the corners (2) suitable for stacking and overturning. Pallet tank for maturing and storage of soft cheeses (3) with reinforcements at its ends (4), sealed with an independent lid (5), peripherally reinforced (6), with a cavity (7) for receiving a food graded gasket (8), on the lid there is a union for brine filling (10), a union for brine level indicator-relief (9), a sampling valve for a syringe use and a perforated sheet-defector (11). The sealing is achieved with special locks such as latch type clamps, or eccentric cams or lever type. The pallet tank bears a base of beams (12), which allows stacking. The reinforcements and the base are fully welded closed sections. The traceability of the pallet tank is achieved by using tag, in which all data of the cheese are being electronically stored.

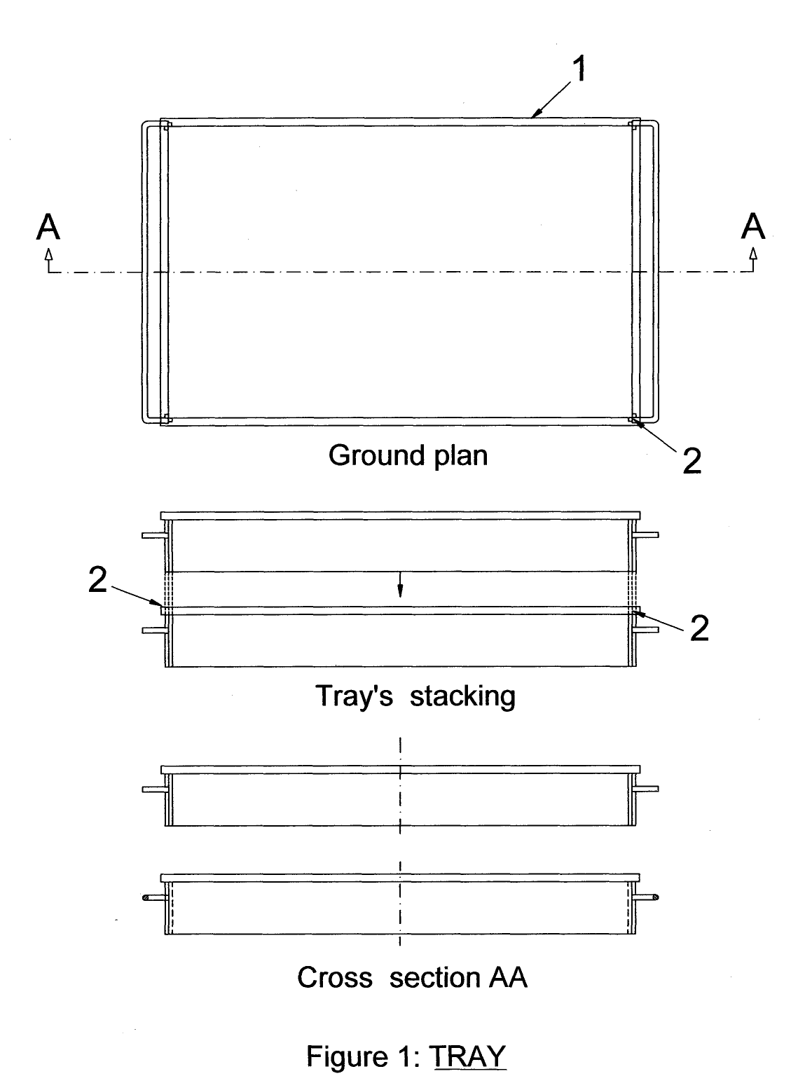

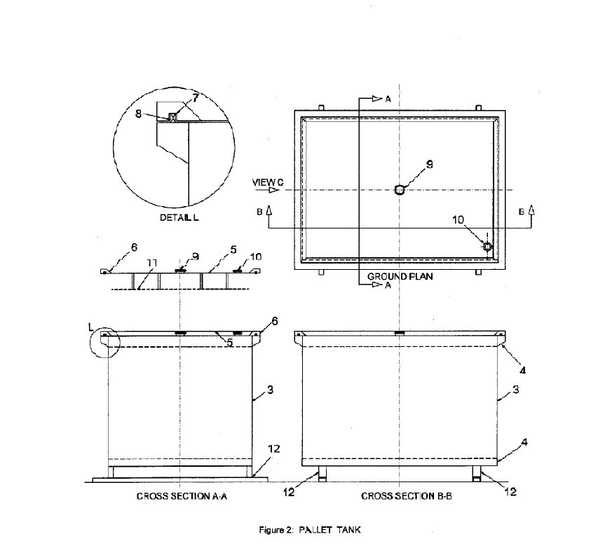

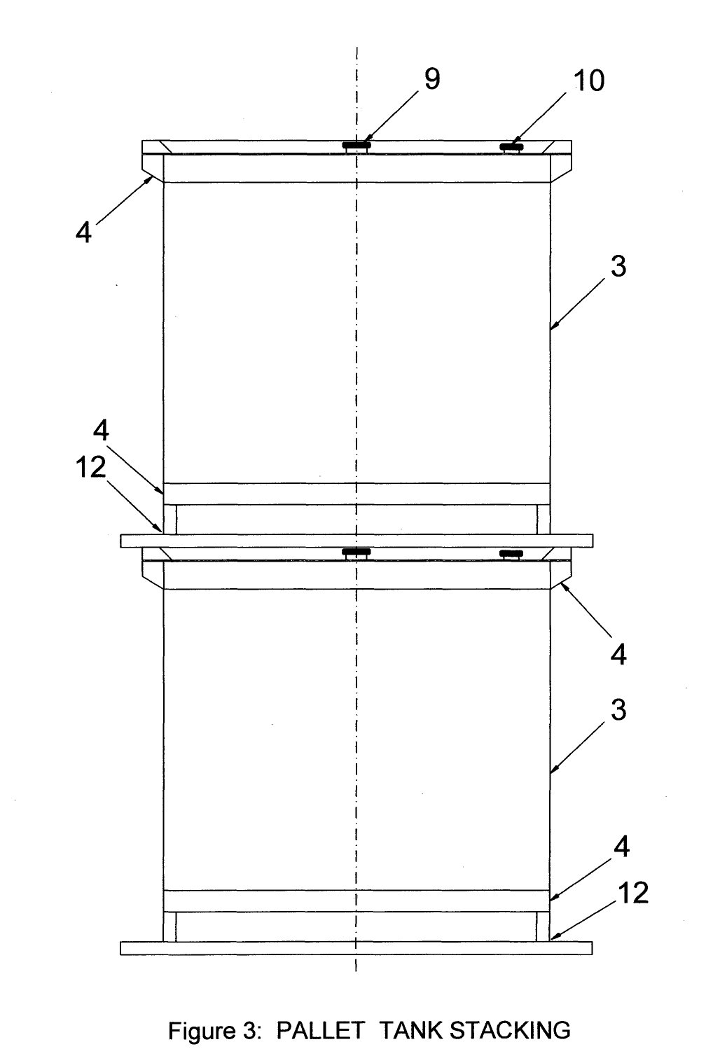

The present invention relates to the process method of production of white cheeses in brine, using stackable trays (1) (2) and pallet tanks or only pallet tanks (3), during the second stage (salting—maturing) and the third stage (ripening—storage) of the production process. During these stages the cheese already has its final shape, because it has firstly been processed and remained in the multiblocks for 18-22 hours, discarding the whey (drainage).

The method of cheese production is widespread by the means and the methodology used for salting, maturing and storage of cheese.

The second stage of the production process is essentially salting and maturing of the cheese in masses, in order to achieve uniformity of structure, format and concision—homogeneity in salt of the final product. The second stage of the production process until today is consisted of various phases, as follows:

The cheese is removed from the multiblocks and its placed manually in special containers (with clip on lid) of four (4) layers, with capacity of eight (8) cheese blocks (each cheese block weights approximately 2 kg), where the cheese is salted at each layer, with result for the cheeses below to receive more salt, but also to be squeezed from the other cheeses above. Then, the cheeses are taken out (after˜16 hours) from the containers with the clip on lid and placed in tins (of the same capacity) with lid, which are sealed with a closing machine, filled with brine and transferred to the main maturing room (after being placed in pallets) with an open cap. This entire procedure in non-mechanizable with a great management cost. Afterwards,(after 10-18 days in the maturing room) small amount of brine can be added, the cap is being sealed and the surfaces of the container are being cleaned so as to minimize corrosion (in the presence of brine) during his long stay (45-90 days) in the freezer, where it continues the maturation (maturing-storage, third stage of the production process). Usually, the total maturing time is at least 2 months. This is also a non-mechanizable procedure with a great management cost.

Also, due to the use of the pallet as well as the presence of corrosion into the containers from the brine, functional and health factors arise (maximum stacking height: 3 pallet's height), correspondingly. The need of the market to create a final product with fixed weight (either in containers or in packages), forces the re- opening of the containers which is taking place manually or with the help of machinery, resulting in increased management costs and burdens the environment with the rejection of useless containers. There is high risk of damaging the cheese block during its takeout from the container, as well as there is the possibility of “falling” scraps of chip cans on the product during the opening of the container.

This invention is coming to solve precisely these problems. To minimize the time of transition from one phase to the next (over the maturing time). To eliminate all factors that burden the product hygienically generated during the production process. To reset the functional factors created and have the effect of unevenness of composition and of morphology of the final product. To give the possibility of mechanization of all stages, resulting in easier management. And finally, to minimize as much as possible the production cost, satisfying the market's demand on fixed weight products.

According to this invention, all the above are achieved with the replacement of: a) the classic containers with clip on lid, with the stackable trays (1) and b) the classic tins, with pallet tanks (3), according to each production procedure.

The new method is reflected in two ways of production. During the first way the cheese is removed from the molds and placed in a specially designed tray (1) (for dry salting) at one level (one layer, so the fresh cheeses are not squeezed from those above them), where the effective depth of the tray is 20% larger than the cheese's height and its construction is such that it is suitable for stacking and overturning (2) (due to the reinforcement to its four corners). The tray is waterproof at its three sides and its dimensions are such that the cheese won't “spread”. In the tray, the cheese is salted with dry salt, uniformly for each cheese. The trays are stacked on stainless steel palette with wheels, in order to save space. The next day (after 16 hours) the trays are being turned over in a specially designed floor-standing turner with purpose to drainage the small amount of whey which is microbial affected. With the elimination of this quantity of whey, the long term maturation of cheese is being controlled in a better way. In the next phase, the cheese is removed from the trays and placed in a pallet tank (3), with capacity of about 45 containers: By placing the cheese in the pallet tank, it's filled gradually with brine, so that the cheeses are subjected to a slight lift and not compressed to one another.

Once the last cheese is being placed, the tank is sealed with a special lid (5), it's filled with brine and only the cap (9) of the brine indicator is left open, in order to help the expansion of gases generated during the fermentation procedure (as it happened in the container).

The depth of the tank is such, that there is available space for brine, an amount equal to one and half times the height of cheese. In the special lid is embodied: the brine's filling hole (10) (hygienic union according DIN), the hole of the brine's indicator—expansion hole of the tank (9) (hygienic union according DIN), perforated plate (11) located at a distance equal to the height of a cheese beneath the surface of lid, in order to hold the cheeses underneath the brine. The lid has a peripheral reinforcement zone (6) that aims to a) the mechanical strength and b) the stacking of the containers so as not to compress the sealing rubber. The perforated sheet can be an independent “piece.” At the top and bottom of the tank area there are reinforcement zones. The tightness of the tank is ensured by a rubber (8) appropriate for food with suitable hardness, which is mounted in a socket (7) of the special lid (5) of appropriate size so as to have the necessary amount of compression of the rubber's tightness without distortion. The sealing of the tank is done by using special locks, such as latch type clamps or eccentric cams or lever type, mounted in the upper area of the tank and in the peripheral reinforcement zone of the lid, so that the food graded gasket (8) is compressed evenly for waterproofing. In installations where the hygiene is excellent and strictly controlled, the tank can be “closed” with a special “film” instead of the special lid. The tank is based on four “legs”, closed section, which are “welded” to a beam (in the dimension of width) in pairs (12). The length of the beams is large enough to exceed the width of the tank. In this way, it becomes easier to stack without the precision of “mm”.

With the pallet tank we save space in the maturing rooms because due to the mechanical strength of the tank, the stacking height of the pallet tank is five (5) in height, which means an increase of 65% of the storage capacity without any increase of the cost (because the surface of the storage remains the same) and furthermore abolishment of the pallet on which the 45 containers were placed on. Therefore we reduce management costs. There is no corrosion from the brine (due to special material) in relation to corrosion of tin cans, therefore healthier way of production. In addition, we also save the brine, since the quantity of brine used is much smaller, because the free space of the pallet tank (filled with brine) is much smaller than the free space of 45 containers. Lower labor costs, due to the larger container management (two or three pieces: tank, lid or perforated plate), which is the pallet tank instead of managing one pallet with 45 containers, 45 plastic spacers, 45 lids and 45 caps (181 pieces). There isn't also a closing machine to close the containers. In addition, the use of pallet tanks in the production process leads to the application of uniform and constant amount of salt in all the cheeses and to the best course of fermentative procedure leading to the controlled maturing. At the same time, sampling (for the cheese's check) becomes easier and more representative. With the old method, 3-4 containers per pallet had to be opened to confirm the quality of cheese, while in the tank which opens easier the check of one cheese is enough to leave results for all the cheeses in the tank. With the progress of technology, quick conclusions can be exported about the progress of maturing, through the analysis of the brine in which the cheeses are. For this reason a special valve for use of a syringe can be placed on the tank, in order to take a sample from brine. So we can take the sample of the brine from the tank to the laboratory, without moving the pallet tank and simultaneously to control the level of brine from the indicator. Finally, mechanization is possible due to the special design of the pallet tank (placing cheeses from the trays in the pallet tank, with the help of robots, automatic filling brine, etc.).

Finally, prior to final stage of packaging the pallet tank moves from the maturing room in the refrigerator, with a unique motion control of the level of the brine and the closure of the brine's indicator cap (9). After the end of the maturing process there aren't any expandable tins, because the pallet tank is reusable after washed in a special washing machine, thereby not harming the environment with the waste from the old tins. We have also dramatically reduction of management costs, because the opening of the pallet tank is very easy and we manage a much larger volume of cheese, with a few “moves”. Finally, we have the choice of creating either fixed weight containers or fixed weight portions (according to market's request). The removal of the brine during the takeout of cheese from the pallet tank, is taking place either by the help of a pipe union—cap at the lowest point of the tank or by the automatic brine suction with a self priming pump (removal of brine until the level reaches the lower part of the cheese pick, automatic operation).

For the traceability of the cheese a special electronic register (tag) is placed on the tank, on which all data of cheese are stored electronically, for example: the production date, the product code, milk's batch code as well as any other information from the production procedure. The electronic register has the possibility of data nullification and rewrites new ones. It can be either wireless technology or to be “read” by a special reading contact. In this way, it becomes easier and more functional the “monitoring” of the production procedure by the quality control of each dairy.

At the B′ method everything that occurs at the A′ method is valid; the difference is that during the phase when the cheese is extracted from the molds, it is placed directly in a pallet tank (not initially in trays), a similar construction with the pallet tank of method A′, but shorter in height. In this tank, 4 layers of cheese are being placed (similar to the classical method of the container). Finally, another advantage obtained over the existing method is that the production of white cheese in brine with direct wet salting, removes the previous stage of production (dry salting in special containers with clip-on lid—maturing), which practically means reduction of the costs, using either normal tanks or those with the reduced height.

1. Method for production of white cheese in brine, using stackable trays and pallet tanks or only pallet tanks, which is characterized by the dry salting tray and preparation of maturing, as well as the maturing pallet tank and storage of soft cheeses in brine. The dry salting tray is characterized by: a) the fact that the depth is 20% larger than the height of the cheese, which is in one layer b) that it is tight from all three edges and c) characterized by its construction, which allows stacking and overturning. The maturing pallet tank and storage of soft cheeses in brine is characterized by: a. The fact that includes food graded rubber and locks to seal the lid b. the layout of beams for stacking c. the presence of a union for filling brine d. the existence of an indicator for the level of brine e. the existence of a sampling brine valve g. the existence of a perforated sheet at the bottom of the lid and f. the existence of tag.

2. The tray and the pallet tank according to claim 1 is used for the production and maturing of cheese.

3. The tray for dry salting according to claim 1 is characterized by its depth, which is 20% more than the height of the cheese to ensure not to damage the cheese during stacking and by its structure of construction with forming grooves, in order to allow stacking.
The maturing and storage pallet tank according to claim 1 is characterized by the food graded rubber of proper hardness and such construction that there is no chance of microbial concentration. The food graded rubber is placed around the edge of the pallet tank, in order to create a contact between the pallet tank and the lid.
The lid bears a reinforcement zone that aims to the mechanical strength during stacking. In this zone, a cavity allows the compression of the seal rubber in such a way in order not to damage its elasticity as well as to seal in a proper way, during the stacking of the pallet tanks. In combination with the special locks, such as latch type clamps or eccentric cams or lever type, the tightness of the pallet tank is achieved. The frame of the beams does not allow the burden of the rubber sealing (in the cavity) from the compressive forces due to the stacking of the tanks.

4. The pallet tank according to claim 1 is characterized by a union of filling the brine, from the presence of the brine level indicator, as well as the existence of a sampling brine valve.
The filling union is located on the lid of the pallet tank and during the filling of the brine, the air is being removed from the pallet tank's body from the union of the level's indicator. The indicator of the brine's level allows visual inspection, since during the phase of fermentation small loss of brine might be observed.
The sampling brine valve is a self-closing membrane which allows the use of a syringe, the reception of a sample from the brine to make the necessary microbiological tests and to check the stage of fermentation.
The perforated plate is attached to the underside of the lid and ensures the continuous immersion of the cheese in brine. Finally according to claim 1, the pallet tank is characterized by the presence of the tag located in a visible place on the body of the pallet tank in order the traceability of the pallet tank to become possible. In the tag can actually be stored the entire history of each pallet tank, since virtually the tag is what makes the pallet tank special and unique.
